(19) United States
(12) Patent Application Publication
(10) Pub. No.: US 2005/0236103 A1
(43) Pub. Date: Oct. 27, 2005

(54) Dielectric resonator, dielectric filter and method of producing the same, filter device combined to a transmit-receive antenna and communication apparatus using the same

(76) Inventors: Yasuhiro Sugaya, Osaka-shi (JP); Tomoya Maekawa, Katano-shi (JP); Toru Yamada, Katano-shi (JP); Seiichi Nakatani, Hirakata-shi (JP)

Correspondence Address: WENDEROTH, LIND & PONACK, L.L.P., 2033 K STREET N. W., SUITE 800, WASHINGTON, DC, 20006-1021, US

(21) Appl. No.: 11/148,347

(22) Filed: Jun. 9, 2005

Related U.S. Application Data
(62) Division of application No. 10/173,729, filed on Jun. 19, 2002.

(30) Foreign Application Priority Data
Jun. 19, 2001 (JP) P 2001-184478

(51) Int. Cl. C09J 5/00

(52) U.S. Cl. 156/305; 156/307.5

(57) ABSTRACT

A dielectric resonator includes a pair of dielectric substrates opposed to each other and resonator electrodes disposed between the pair of dielectric substrates. The resonator electrodes are disposed so as to be brought into contact with major surfaces of the pair of dielectric substrates, and a bonding layer is disposed around the resonator electrodes so as to bond the pair of dielectric substrates. The pair of dielectric substrates have been sintered in advance at sufficiently high temperature which is a dielectric having an fQ value at 1 GHz in the range of 3×10³ to 1×10⁵, and then achieve a high Q value as a filter. The pair of the substrates are provided with a surface roughness of a range of 0.1 to 2.0 μm, and flatness of 10 μm or less between both ends thereof to bring the resonant electrodes in close contact with the surfaces of the substrate. Such ceramic filters are used comfortably for a filter connecting a transmit-receive antenna to a transmitter and receiver, which can provide communication equipment having a good high frequency performance for cellular telephone systems.

This application is a divisional application of application Ser. No. 10/173,729, filed Jun. 19, 2002.

### BACKGROUND OF THE INVENTION

1. Field of the Invention

The present invention relates to a dielectric resonator and a dielectric filter using the same. In particular, the present invention relates to a stripline type dielectric resonator using a high permittivity material with a high fQ value, and a method of producing such a dielectric resonator and dielectric filter. Furthermore, the present invention relates to a filter device combined to a transmit-receive antenna and communication apparatus for high-frequency radio equipment including a cellular telephone.

2. Prior Art

In recent years, many dielectric filters are used for a high frequency or microwave filter in a cellular phone. A microwave stripline filter is used as a band pass filter or a band elimination filter in the microwave range. These dielectric filters are so thin as to be suitable to be mounted on a circuit board.

Various forms of stripline filters are known. The stripline resonator includes a tri-layered type, which has a pair of dielectric substrates and a stripline disposed therebetween. Such dielectric resonators are widely used for filters, voltage-controlled oscillators and frequency synthesizers.

In a conventional method of producing these dielectric resonators, the dielectric resonator is formed by applying a plurality of striplines of silver Ag or copper Cu to be resonance electrodes on a ceramic green sheet, laminating on the green sheet another green sheet and then firing the green sheet laminate at a temperature lower than 900° C. so as not to melt the metal strips. This sintering process integrates the dielectric substrates and resonator electrodes therebetween.

Another producing method is known in which substrates are sintered from a dielectric ceramic at high temperature and resonator electrodes made of metal are interposed between a pair of the sintered substrates. Then, the dielectric substrates and the resonator electrodes are bonded with a molten glass frit or the like, obtaining a resonator.

However, in the above conventional method of producing a resonator, since the resonator electrodes are sintered at the same time when the green sheets are sintered, the dielectric material has a risk of containing impurities, for example, such as a glass frit or a glass component rich in bismuth Bi. In the case of this conventional process, the resulting resonator has lower crystallinity of the dielectric formed upon sintering and lower permittivity, as compared with resonators of a type obtained by essentially sintering the dielectric substrates at high temperature, then hardly obtaining a high Q value.

Furthermore, in such a dielectric resonator obtained by sintering dielectric resonators at the same time, the pair of sintered dielectric substrates are secured with a glass frit as in the conventional cases, but cracks are often generated in the dielectric substrates depending on the thickness of the resonator electrodes, or the glass frit and melted glass enter between the resonator electrodes and the dielectric substrates. This deteriorates characteristics of the resonator, thereby making the resonator unstable.

### SUMMARY OF THE INVENTION

An object of the present invention is to provide a dielectric resonator using a high-temperature sintered type ceramic dielectric with a high Q value, which has good resonance characteristics with low dielectric loss and can be made smaller and thinner.

Another object of the present invention is to provide a dielectric filter which uses a high-temperature sintered type ceramic dielectric with a high Q value and has good filter characteristics of low transmission loss.

Yet another object of the present invention is to provide a method for producing a dielectric resonator by using a high-temperature sintered type ceramic dielectric with a high Q value, a dielectric resonator having few defects during producing processes, good resonance characteristics and low dielectric loss and being made smaller and thinner.

Yet another object of the present invention is to provide a method of producing a dielectric filter by using a high-temperature sintered type ceramic dielectric with a high Q value a dielectric resonator having good filter characteristic and low transmission loss.

The dielectric resonator of the present invention is a laminated dielectric resonator formed by integrally bonding a pair of dielectric substrates opposed to each other and resonator electrodes disposed between the dielectric substrates, wherein the resonator electrodes are brought into contact with surfaces of the pair of dielectric substrates and a bonding layer containing a resin is disposed between the pair of dielectric substrates around the resonator electrodes so as to bond the pair of dielectric substrates.

In particular, the resonator electrodes may be of at least a pair of striplines arranged in parallel and each strip thereof resonates with particular high-frequency signals which is electromagnetically coupled to other.

In the dielectric resonator of the present invention, external electrodes for output electrodes may be formed at least on part of outer surfaces of the pair of dielectric substrates and coupled to the resonating electrodes.

It is preferable that the resonator electrodes have wide portions on an open end side of the pair of striplines, which can easily adjust an electromagnetic coupling coefficient between the pair of striplines by changing the shape of the wide portions.

The resonator electrodes may be made of a metal foil having low electric resistance and disposed so as to directly join to dielectric substrates having high permittivity to form a stripline-type dielectric resonator with a high Q value. Such a dielectric resonator has good filter characteristics for use in a dielectric filter application.

The present invention includes methods of producing the above-described dielectric resonator. One of the methods includes steps of disposing resonator electrodes made of a metal foil between main surfaces of a pair of dielectric substrates obtained by sintering a dielectric and integrally laminating these layers; and, filling a space around the resonator electrodes between the pair of dielectric substrates with an adhesive containing a resin, and curing the adhesive to form a bonding layer.

Another of the methods of producing a dielectric resonator includes steps of applying a B-stage adhesive to a main surface of either one of a pair of dielectric substrates obtained by sintering a dielectric except for regions in which resonator electrodes are formed; printing and filling a conductive paste in the regions in which the resonator electrodes are formed; and making the main surface of the other dielectric substrate opposed to the main surface of the one dielectric substrate, that is, on the surface on which the resonator electrodes are formed and applying pressure and heat from both surfaces of both the dielectric substrates to cure the adhesive and the conductive paste so that the bonding layer, the resonator electrodes and the dielectric substrates are integrally bonded.

The above producing methods, generally, utilize a dielectric ceramic which is sintered at high temperature in advance and has a high fQ value for dielectric substrate with the resonator electrodes brought in direct contact with the dielectric substrates, then obtaining the dielectric resonator having a high resonance Q value.

These methods can include a firing step of laminating a plurality of green sheets made of a dielectric ceramic and sintering them to prepared a plurality of dielectric substrates.

Also, these methods may include a step of forming an external electrode in advance on the surface of the dielectric substrate except for the main surface on which the resonator electrodes should be formed.

Another method of producing the dielectric resonator of the present invention includes steps of providing a punched portion, that is, opening portions in a resin sheet, each opening having a shape larger than the shape of the resonator electrode, in advance and preparing a prepreg by inserting the resonator electrodes made of a metal foil into the opening portions; laminating while interposing the pre-preg from both surfaces thereof between a large number of dielectric substrate pairs; applying heat and pressure to the pair of dielectric substrates from the outer surfaces thereof and thereby curing a resin sheet in a pre-preg state to form a bonding layer so that the dielectric substrates and the resonator electrodes are integrally bonded by the bonding layer; and cutting the resin sheet so as to separate it into a large number of single dielectric resonators.

Yet another producing method includes steps of providing punched portions, that is, opening portions, each having a shape larger than the shape of the resonator electrode, in a long resin sheet in advance and preparing a pre-preg by inserting the resonator electrodes made of a metal foil into the punched portions; laminating while interposing the pre-preg from both surfaces thereof between a pair of large dielectric substrates; applying heat and pressure to outer surfaces of the pair of dielectric substrates and thereby curing a resin sheet in a pre-preg state to form a bonding layer so that the dielectric substrates and the resonator electrode are integrally bonded by the bonding layer; and cutting the laminated dielectric substrates so as to separate them into a large number of single dielectric resonators.

This producing method using a pre-preg or an electrode carrier film has excellent mass productivity since an assembly process is simplified due to use of a long electrode carrier film.

The above producing method using an electrode carrier film may also include a step of forming external electrodes. This method can include a step of forming an external electrode at least on part of one main surface of a dielectric substrate prior to a step of disposing resonance electrodes and an adhesive film between a pair of the dielectric substrates, and thereafter, the resonance electrode and the adhesive film are disposed on the other main surface of the dielectric substrate.

Another method can include a step of forming an external electrode after a step of disposing resonance electrodes and an adhesive film between a pair of dielectric substrates, laminating these layers, and cutting the laminate into individual pieces to form dielectric resonators. Such an external electrode can be formed by plating or thermally spraying the substrate surface with a metal.

The resin sheet in the above methods may include a composite film containing an inorganic filler in an adhesive resin.

The dielectric filter of the present invention includes a laminated dielectric filter formed by integrally bonding a pair of dielectric substrates opposed to each other and resonator electrodes disposed between the dielectric substrates, wherein the resonator electrodes are brought into contact with surfaces of the pair of dielectric substrates, and a bonding layer containing a resin is disposed around the resonator electrodes so as to bond the pair of dielectric substrates, one of which includes an interstage coupling capacitor electrode on the opposite surface, the other including input/output coupling capacitor electrodes and the resonator electrodes are connected to each other by an electromagnetic field.

The present invention further includes a method of producing such a dielectric filter, which includes steps of disposing an interstage coupling capacitor electrode between two dielectric ceramic green sheets laminated in a predetermined thickness by printing or the like; disposing an input/output coupling capacitor electrode between another pair of dielectric ceramic green sheets similarly laminated in a predetermined thickness by printing or the like; firing the dielectric ceramic green sheets, and forming an external electrode on a predetermined outer peripheral surface to form an interstage coupling capacitor substrate and an input/output coupling capacitor substrate; and interposing resonator electrodes between the interstage coupling capacitor substrate and the input/output coupling capacitor substrate, injecting and filling a bonding layer made of an adhesive such as a thermosetting resin or the like around the resonator electrodes, and applying heat and pressure to cure the adhesive so that the interstage coupling capacitor substrate, the input/output coupling capacitor substrate and the bonding layer being integrally bonded. Thus, a dielectric filter having an excellent filter characteristic can be provided.

Such a filter is provided as a transmitting filter, a receiving filter or a high-frequency filter for a transmit-receive antenna used as both of these in a radio communication system. The dielectric filter can be used for radio communication equipment, particularly in a form of a filter for a single antenna for both sending and receiving signals.

### BRIEF DESCRIPTION OF THE DRAWINGS

The present invention is described below in detail with reference to the accompanying drawings, in which:

FIG. 1A is an exploded perspective view showing a dielectric resonator according to an embodiment of the invention;

FIG. 1B is a cross sectional view showing the dielectric resonator in FIG. 1A;

FIGS. 2A-2F are cross sectional views showing steps of producing a dielectric resonator according to anther embodiment of the invention;

FIGS. 3A-3G are cross sectional views showing steps of producing a dielectric resonator according to yet anther embodiment of the invention;

FIGS. 4A-4G are cross sectional views showing steps of producing a dielectric resonator according to another embodiment of the invention;

FIGS. 5A-5E are cross sectional views showing steps of producing a dielectric resonator according to another embodiment of the invention;

FIGS. 6A-6F are cross sectional views showing steps of producing a dielectric resonator according to another embodiment of the invention;

FIG. 7 is a plan view showing shapes of resonator electrodes of a dielectric resonator according to another embodiment of the invention; and

FIG. 8 is a block diagram showing a filter used for a single transmit-receive antenna according to another embodiment of the invention.

### DETAILED DESCRIPTION OF THE PREFERRED EMBODIMENTS

### Embodiment 1

The dielectric resonator of the present invention is a laminated dielectric resonator obtained by integrally bonding a pair of dielectric substrates and resonator electrodes disposed between the dielectric substrates, and is characterized in that the resonator electrodes are brought into contact with surfaces of the pair of dielectric substrates, and that a bonding layer containing a resin is disposed around the resonator electrodes so as to bond the pair of dielectric substrates.

In the present invention, the dielectric substrate preferably has a fQ value in the range of 3×10³ to 1×10⁵ at a frequency of 1 GHz.

Here, the fQ value of a dielectric is a quality factor for a material at a frequency of 1 GHz, which is defined as the product of 2n and a ratio of stored energy in a material supplied in one cycle of a given frequency with respect to consumed energy in the material in that cycle.

When the fQ value is less than 3×10³, the dielectric resonator cannot achieve a sufficient resonance characteristic. On the other hand, it will be very difficult to achieve quality factor characteristics obtained with an fQ of more than 1×10⁵ because no dielectric material having a higher permittivity than 30 can be available.

According to the present invention, the dielectric may preferably be a ceramics material which has been sintered at sufficiently high temperature in advance so as to be made dense and has high permittivity and low dielectric loss. Such a dielectric material can be selected from Zr—Ti—Mg—Nb—O, Bi—Nb—O, Ba—Ti—O, Ba—Nd—Ti—O or Ba—Sm—Ti—O based oxides.

The dielectric substrate preferably has high smoothness and planarity. The high smoothness and planarity enable the resonator electrodes and the dielectric substrates to be brought into direct contact with each other and prevents the bonding layer from entering therebetween. Consequently, the resonator can exhibit a resonance characteristic with a high Q value.

From this viewpoint, as a degree of smoothness of the dielectric substrate, the main surface to be brought into contact with the resonance electrodes preferably has roughness of 2.0 μm or less. When the surface roughness exceeds 2.0 μm, conductive resistance of the resonator electrodes to be brought into contact with the surface increases, which is not favorable because the Q value of the resonator decreases. On the other hand, when the surface roughness is made 0.1 μm or less, excess time is required for a step of precision-polishing of the substrates, and hence, costs are increased. Therefore, the surface roughness of the dielectric substrate is preferably in the range of 0.1 to 2.0 μm.

The dielectric substrate preferably has surface planarity of 10 μm or less between both ends of the dielectric substrate. As to the substrate planarity, when the bending of the surface over the distance between both ends of the substrate is 10 μm or more, a gap is formed between a conductor foil and the dielectric substrate, resulting in a lower Q value of the resonator.

Both the main surfaces of the resonator electrode are brought into contact with surfaces of the pair of dielectric substrates and fixed. The resonator electrode can include a copper or silver foil. Furthermore, the resonator electrode can include an alloy foil containing copper or silver as a main component. Such a resonator electrode can be formed of a gold plating layer on the copper foil.

Since electrodes made of these metal materials have low resistance, high-frequency loss of the dielectric resonator is reduced.

Furthermore, a resonator electrode in another form can include a curing body of a conductive paste composed of a powder of copper, silver or an alloy thereof and an organic binder. Such a resin matrix-metal particle curing body can increase adhesion of the resonator electrode to the dielectric substrate surface.

The resonator electrode is formed as a stripline in a pair of dielectric substrates by using such electrode materials. The resonator electrode or the stripline preferably has a thickness in the range of 50-400 μm. Thus, a dielectric resonator with low loss can be obtained.

As the resonator electrodes, those constituted by a pair of striplines arranged in parallel so as to be electromagnetically coupled are adopted, and each stripline resonates. The resonator electrodes are made of a metal foil having low resistance and disposed so as to adhere to the dielectric substrates having high permittivity. Thus, a stripline-type dielectric resonator with a high Q value is provided. Such a dielectric resonator can be used for a dielectric filter having an excellent filter characteristic.

Furthermore, the thickness of the resonator electrode is preferably in the range of 50-400 μm to reduce insertion loss as a dielectric filter. When the thickness of the resonator electrode is 50 μm or smaller, resistance of the electrode conductor increases, and the Q value is decreased. When the thickness of the resonator electrode is 400 μm or greater, the resonator itself becomes too thick, which is not favorable since it is difficult to make the resonator compact even though the Q value becomes higher due to the increase in the electrode thickness.

In this embodiment, an external electrode is formed at least on part of each outer surface of the pair of dielectrics. The external electrode is grounded and used as a shield.

The bonding layer is filled in a space between the dielectric substrates to bond the dielectric substrates to each other. A cured adhesive of thermosetting resin can be used as the bonding layer. Furthermore, a composite containing a thermosetting resin and an inorganic filler can also be used for the bonding layer. This can increase adhesion of the pair of dielectric substrates.

The bonding layer preferably has permittivity lower than ¼ times permittivity of the dielectric substrates. A low permittivity in the bonding layer may effectively prevent a dielectric field derived from two resonator electrodes from converging in the bonding layer within the range around the two resonator electrodes, then maintaining the dielectric resonator high in Q value. For the thermosetting resin, epoxy resin is preferably used since it has low permittivity, excellent high-frequency performance and, in particular, low dielectric loss. Furthermore, silica may be included as an inorganic filler in the adhesive for composite bonding layer. The peripheral end portion of the bonding layer can be protruded from side surfaces of the dielectric substrates, and the protruded bonding layer periphery can insulate the external electrode attached to the outer surfaces of the dielectric substrates.

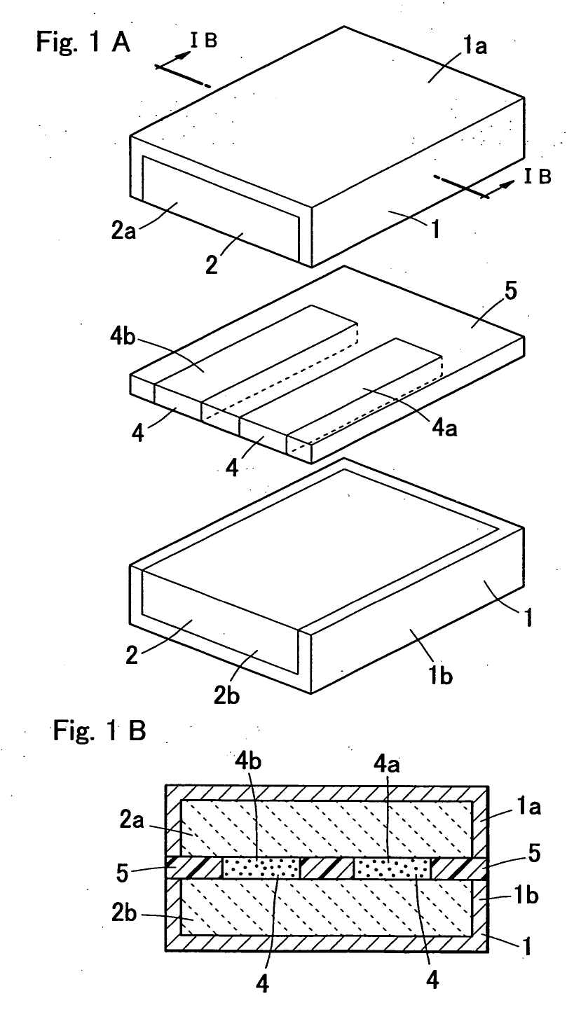

FIGS. 1A-1B show one example of the dielectric resonator according to this embodiment, which includes a pair of dielectric substrates 2 and 2 and a pair of striplines 4 and 4, as resonator electrodes 4a and 4b, disposed between the dielectric substrates 2, 2. This dielectric resonator includes a resin layer 5 disposed around the pair of striplines 4 and 4 between these dielectric substrates 2, 2 and so as to integrally bond the dielectric substrates 2, 2, constituting a resonator.

In this example, the dielectric substrates 2 and 2 are sheets made of a Ba—Ti—O ceramic having a thickness of 1 mm, and the resonator electrodes 4 are made of a copper (Cu) foil having a thickness of about 100 μm. The adhesion layer 5 is a thermosetting epoxy resin.

In this embodiment, an outer surface of the assembled dielectric resonator is coated with an external electrode 1 except for part of a side surface and is utilized as a shield electrode to be grounded.

As described above, according to this embodiment, a dielectric material that is fired at high temperature and has a high fQ and high relative permittivity can be used for dielectric substrates that cannot be conventionally fired at the same time as a silver or copper resonator electrode material is fired. Therefore, the dielectric resonator of this structure has high resonance characteristics and a highly compact shape, which improves the characteristics of the dielectric filter in a miniaturized shape with low insertion loss.

### Embodiment 2

One method of producing a dielectric resonator includes steps of preparing a pair of dielectric substrates by sintering a ceramic in advance, disposing resonator electrodes made of a metal foil between one main surfaces of the pair of dielectric substrates and laminating these integrally, and filling an adhesive containing a resin in a space around the resonator electrodes between the pair of dielectric substrates and curing the adhesive to form a bonding layer. Since both the surfaces of the resonator electrodes are brought into direct contact of the dielectric substrates and fixed, the resonator can exhibit a high Q value. Furthermore, risks of occurrence of breakage or cracks of the substrates and the electrodes during these producing processes can be reduced.

In this method, a plurality of green sheets made of a dielectric ceramic powder of the aforementioned oxides are laminated and sintered in advance to form a dielectric substrate.

This producing method can include an external electrode formation step of forming an external electrode at least on part of the other main surfaces of the pair of dielectric substrates. The external electrode is grounded and used as a shield electrode upon use of the resonator. The external electrode formation step can be implemented prior to the step of disposing the resonator electrodes. The external electrode formation step may also be implemented after the bonding step, and an external electrode is formed on the outer surfaces of the integrally bonded dielectric substrates of the resonator.

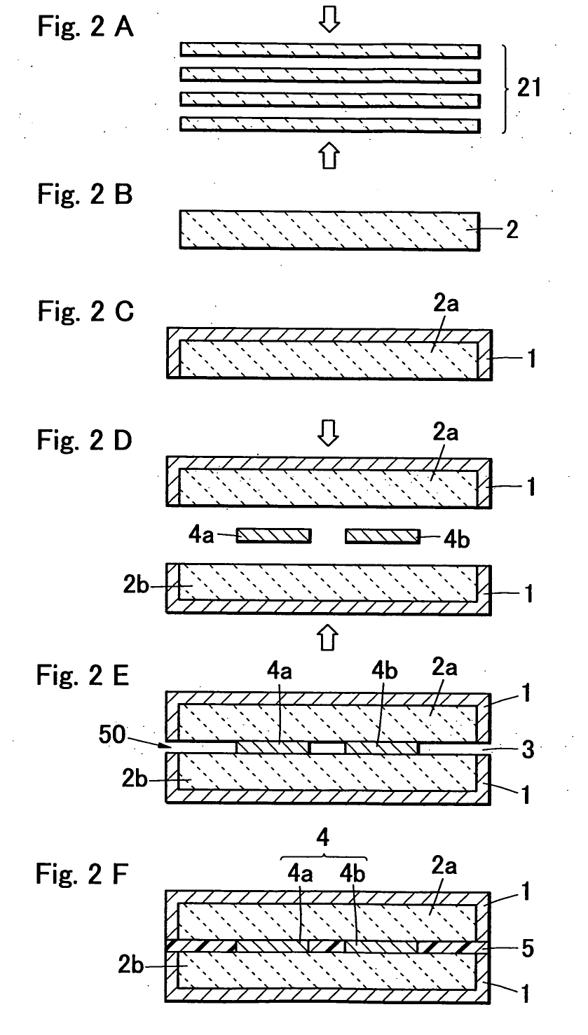

As a specific embodiment of the method of producing a dielectric resonator of the present invention, a green sheet 21 made of a slurry obtained by mixing a dielectric ceramic powder and an organic binder is prepared as shown in FIG. 2A. A plurality of the green sheets 21 are laminated and sintered at high temperature to obtain a dielectric substrate 2 as shown in FIG. 2B.

Subsequently, as shown in FIG. 2C, a pair of dielectric substrates are coated with a conductive paste containing metal silver Ag as a main component except for one predetermined main surface and subjected to sintering or the like to form an external electrode 1.

Subsequently, the other main surfaces of the pair of dielectric substrates 2a, 2b formed as described above (that is, main surfaces on the opposite side of the main surfaces on which the external electrode 1 is formed) are made opposed to each other as shown in FIG. 2D, two striplines 4a, 4b, which constitute resonator electrodes 4, are disposed between the two opposed main surfaces, and then the dielectric substrates 2a, 2b are bonded.

As shown in FIG. 2E, a thermosetting epoxy resin 50 is filled in a space 3 between the bonded dielectric substrates 2a, 2b and cured by heat.

In FIG. 2F, a bonding layer 5 is formed by the thermosetting resin 50, and a dielectric resonator can be manufactured by integrally bonding a pair of dielectric substrates 2a, 2b and resonator electrodes 4 constituted by a pair of striplines 4a, 4b.

In this embodiment, after the resonator electrodes 4a, 4b are bonded by applying pressure from both surfaces of the dielectric substrates 2a, 2b, an adhesive 50 such as an epoxy resin or the like is injected into the space 3 between the dielectric substrates. Therefore, the resonator electrodes 4a, 4b and the dielectric substrates 2a, 2b can be bonded strongly without allowing an adhesive to enter therebetween.

### EXAMPLE 1

Dielectric resonators were produced according to this embodiment to determine their resonator characteristics. In this example, a slurry was prepared from a Zr—Ti—Mg—Nb—O based oxide powder mixed with an acrylate binder, and was made in the form of ceramic green sheets, a fixed number of which were stacked and fired at 1350° C. to ceramic substrates of about 1 mm in thickness. Also, in this example, external electrodes were applied on all the surfaces, excluding major surfaces on which resonator electrodes are to be applied, of the substrates, by sintering a silver paste at 850° C. on the surfaces.

A pair of copper foils having a thickness of 100 μm and a width of 1 mm are arranged parallel between a pair of dielectric substrates to form a pair of striplines each side of which may be brought in direct contract with a corresponding major surface of each of the dielectric substrates. Thereafter, as shown in FIG. 2E, an epoxy resin adhesive for a bonding layer was filled in a gap between the pair of dielectric substrates and was cured by heating while pressing the outsides of the substrates, obtaining dielectric resonators as sample A.

As comparison examples, resonator electrodes were inserted into a pair of substrates produced in a similar manner to the above example and the substrates were filled with the same adhesive in a gap between both the substrates while the substrates were not pressed enough on the outsides of the substrates to bring the metal foils of the resonator electrodes in intimate contact with the major surfaces of the substrates, and then were cured, resulting in part of the adhesive being inserted into a clearance between the metal foil and the substrate. Thus, dielectric resonators for samples B and C were prepared.

These samples were tested for determining resonating properties, and the test results are shown in Table 1.

TABLE 1

| | clearance | | |
|---|---|---|---|
| | electrode- | | |
| | substrate | resonating | |
| Sample | μm | frequency GHz | Q |
| A | 0 | 2.11 | 332 |
| B | 20 | 2.13 | 180 |
| C | 40 | 2.08 | 144 |

It is found from Table 1 that any slight clearance between a substrate and a resonator electrode, such as a metal foil, in which adhesive material can be inserted rapidly decreases Q values of the resulting dielectric resonators. This leads to the fact that High Q resonators must have both surfaces of each resonator electrode in direct contact with a pair of substrates.

### Embodiment 3

The method of producing a dielectric resonator according to this embodiment includes steps of applying an adhesive in a B-stage on either of main surfaces of a pair of dielectric substrates except for regions in which resonator electrodes are formed; printing and filling a conductive paste in the region in which the resonator electrode is formed; making the main surface of the other dielectric substrate oppose the main surface of the above dielectric substrate, that is, the surface on which the resonator electrode is formed, and heating under pressure both outer surfaces of the dielectric substrates to cure the adhesive and the conductive paste so that the bonding layer, the resonator electrodes and the dielectric substrates are integrally bonded.

According to this embodiment, as the conductive paste, the one containing conductor particles and a thermosetting resin binder can be used. The conductive paste has advantages that it can form a resonator electrode and bond the dielectric substrates at the same time and that adhesion of the resonator electrode to the dielectric substrates can be ensured.

As the conductive paste, a thermosetting resin can contain a pyrolytic metal organic matter, for example, metal alkoxide (Me-O—R). When this kind of a paste is heated after being applied to the substrate main surface, the paste is thermally decomposed (MOD method) and deposits a metal. Thus, the resonator electrode 4 can be formed.

In this method as well, a plurality of green sheets made of a dielectric ceramic can be laminated and then sintered to form dielectric substrates. An external electrode may be formed on the other surface of the dielectric substrate in advance.

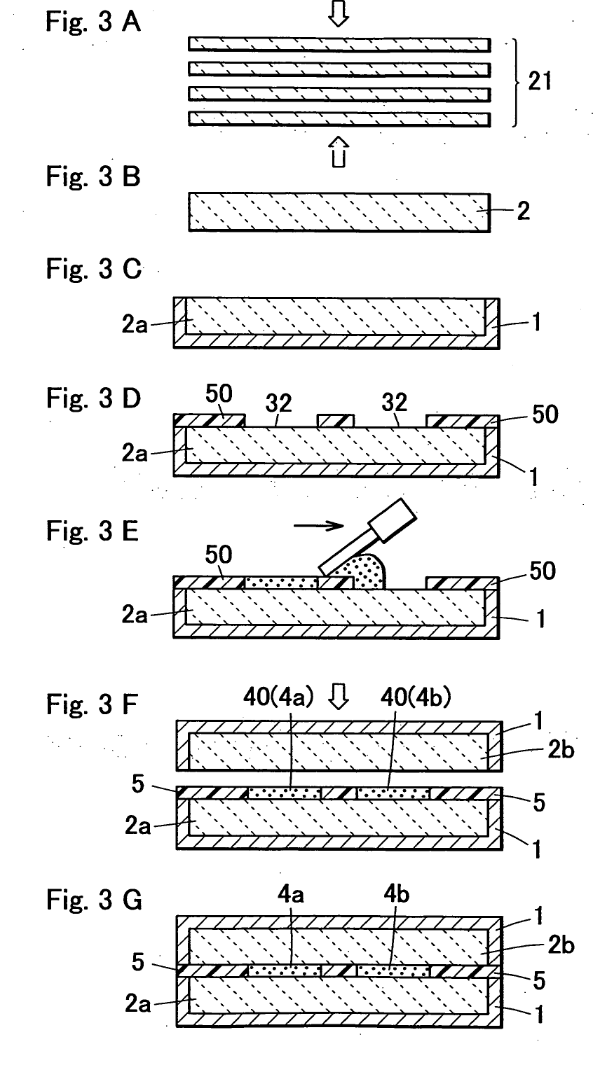

As an example of the method of producing a dielectric resonator according to this embodiment, steps in FIGS. 3A and. 3B are implemented as shown in the steps in FIGS. 2A and 2B, and a plurality of ceramic green sheets 21 are laminated and sintered to form dielectric substrates 2.

Subsequently, as shown in FIG. 2C, first, an external electrode 1 is formed on all the surfaces of the pair of dielectric substrates 2a, 2b except for one main surface of each, as in the case of Embodiment 1.

In either one of the dielectric substrates, an adhesive 50 made of a thermosetting epoxy resin is selectively screen-printed on top of the one main surface through a pattern screen so that predetermined regions in which striplines should be formed are excluded. The printed substrate is heated to cure the adhesive 50 into B stage as shown in FIG. 3D.

Subsequently, as shown in FIG. 3E, a conductive paste 40 made of silver particles and an epoxy resin is screen printed in regions 32 in which the adhesive 50 is not disposed on the main surface of the dielectric substrate 2a by using a squeegee.

The other dielectric substrate 2b is disposed on the surface of the printed dielectric substrate 2a, and the outsides of the two dielectric substrates 2a, 2b are heated as shown in FIG. 3F to cure the adhesive 50 and the conductive paste 40 completely. As a result, as shown in FIG. 3G, a pair of dielectric substrates 2a, 2b interpose striplines 4a, 4b, which constitute resonator electrodes 4 therebetween, and these are integrally bonded by a bonding layer 5 to form a dielectric resonator.

### EXAMPLE 2

As an example of this embodiment, dielectric resonators were produced according to this embodiment. A plurality of green sheets made of Ba—Nd—Ti—O based ceramic were stacked in laminates, and fired at 1350° C. into sintered ceramic substrates as dielectric substrates. All of the surfaces, excluding major surfaces on which resonator electrodes are to be formed, of a first and second dielectric substrates were subjected to the sintering of silver paste to form external electrodes.

An epoxy resin adhesive was applied on a first substrate to make an adhesive pattern without covering the outer shape of a pair of striplines on its major surface, and then cured into up to B-stage condition. A pair of silver foil cut out into the fixed shape of striplines were inserted to the areas which have been not covered with the adhesive layer, in order to produce the configuration of the striplines by the foil, and then a second substrate was placed onto the major surface of the first substrate in contact with the metal foil of striplines. Both the substrates with the inserted metal foil therebetween were heated at 150° C., while pressing them, to completely cure the adhesive layer, and then are incorporated into a dielectric resonator.

As comparative examples, utilizing the same dielectric substrates produced as in the above example, a glass-containing paste as a glass adhesive was selectively applied on a major surface, on which no outer electrode is formed, of a first dielectric substrate to make a patterned adhesive layer. In a same manner as in the above example, a pair of silver foils having configuration of striplines are inserted into the openings having the form of striplines in the patterned adhesive layer, and a second substrate was placed onto the glass adhesive applied on the first substrate.

Both the substrates with the inserted metal foil therebetween were heated, in this case, at about 600° C. for melting the glass adhesive, while pressing them, and cooled to completely attach both the substrates with the glass bonding layer, and then incorporated into a dielectric resonator.

The dielectric resonators from the above example and comparative example were tested to measure their resonator characteristics. The results are shown in Table 2.

TABLE 2

| | electrode | | | distance | |
|---|---|---|---|---|---|
| adhesive | distance | resonat. | | electrode | |
| material | mm | frequen. | Q | substrate | appearance |
| resin adhesion | 2.059 | 2.212 | 321 | 0 | no |
| | | | | | cracks |
| glass adhesion | 2.089 | 2.187 | 108 | 12 | cracks |
| | | | | | around |
| | | | | | electrodes |

As shown in Table 2, the dielectric resonators according to this embodiment show high Q resonating characteristics, since resin adhesive materials for an adhesive layer, because of low adhesion operating temperatures and low elastic modulus, can directly attach each side of a resonator electrode such as metal foils to corresponding major surfaces of a pair of dielectric substrates.

On the other hand, in the comparative example as shown in Table 2, though the dielectric resonator had been expected to have a high Q value by directly attaching the metal foil to the surfaces of previously sintered dielectric ceramic substrates with a high fQ value, actually the application of glass paste resulted in a lower Q value. This is because part of glass component which is melted during the adhesion step flows between the metal foil and the adjective surface of the dielectric substrate, allowing cracks to occur in the glass bonding layer around the metal foils as resonator electrodes.

### Embodiment 4

According to this embodiment, a B-stage adhesive resin sheet is provided with punched portions each having a shape larger than the shape of a resonator electrode, and resonator electrodes made of a metal foil are disposed and inserted at the punched portions to form a prepreg, that is, an electrode carrier film.

The electrode carrier film is interposed between a pair of dielectric substrates so that each corresponding main surface is disposed on each of the resonator electrodes. A dielectric resonator is formed by steps of applying pressure and heat to the pair of dielectric substrates from outer surfaces thereof to cure the adhesive resin sheet in a B stage and thereby form a bonding layer so that the dielectric substrates and the resonator electrodes are integrally bonded by the bonding layer and cutting the electrode carrier film to separate it into individually dielectric resonators.

By this producing method, a single dielectric resonator can be formed by a single adhesive resin sheet. Furthermore, by this producing method, by using a long adhesive resin sheet, a large number of pairs of resonator electrodes are disposed so as to be interposed by a large number of corresponding pairs of dielectric substrates and thereby form a large number of dielectric resonators, and then separated to individual dielectric resonators for mass production.

The adhesive resin sheet can be a B-stage thermosetting resin sheet or a composite film obtained by mixing a thermosetting resin in an inorganic filler. As the thermosetting resin, for example, an epoxy resin can be used. The inorganic filler can be a fine silica powder.

Instead of the adhesive resin sheet, a non-adhesive resin sheet can also be used. As such a non-adhesive resin sheet, a resin sheet having an extremely small dielectric loss tangent without adhesiveness such as polyester or tetrafluoroethylene can be used. In this case, the surface of the resin sheet is coated with an adhesive resin solution, for example, a thermosetting epoxy resin adhesive, and can be bonded to the dielectric substrates as a bonding layer. This bonding layer has an advantage that even when an electric field enters this layer, the Q value is not decreased.

In this embodiment, since a film-like bonding layer is used to provide opening portions for disposing resonator electrodes therein, an arbitrary space can be formed between the bonding layer and the resonator electrodes by making the size of the opening portions larger than the shape of the resonator electrode.

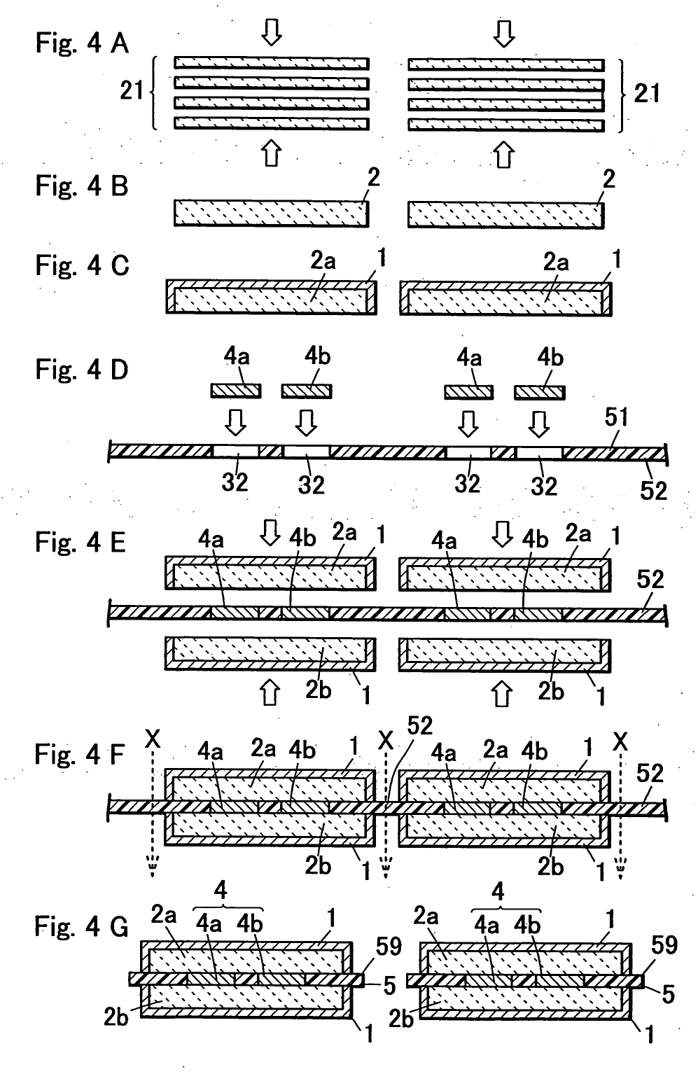

FIGS. 4A-4G show a method of producing a large number of dielectric resonators in a series of steps as an example of this embodiment.

First, in steps shown in FIGS. 4A-4C, dielectric ceramic green sheets 21 are formed as in the steps shown in FIGS. 2A-2C shown in Embodiment 1 and some green sheets are laminated and sintered to form dielectric substrates 2a, 2b.

Subsequently, as shown in FIG. 4D, in another step, a long thermosetting resin sheet 51, for example, a B stage epoxy resin sheet, is provided with a large number of opening portions 32, 32 each having a shape slightly larger than the outer shape of a stripline constituting a resonator electrode by punching at predetermined consistent intervals.

In the long resin sheet, the resonator electrodes constituted by the striplines 4a, 4b made of metal are inserted into the opening portions 32 as shown with arrows. As a result, an electrode carrier film 52 is prepared. Thus, the electrode carrier film 52 is provided as a long sheet including a large number of resonator electrodes 4 and a bonding layer 59.

Subsequently, as shown in FIG. 4E, the electrode carrier film 52 prepared in FIG. 4D is successively interposed between a large number of pairs of the dielectric substrate 2a, 2b from both surfaces thereof. At this time, upper and lower dielectric substrates are laminated so that each pair of the striplines embedded in the electrode carrier film 52 and the corresponding main surfaces are bonded. Then, pressure and heat are applied to both the dielectric substrates from above and below as shown with arrows in the figure, and the dielectric substrates, the resonator electrodes and the bonding layer are integrally bonded. Then, the electrode carrier film 52 is cut at point X shown in FIG. 4F in a gap between the adjacent dielectric substrates to separate into single dielectric resonators as shown in FIG. 4G.

In this embodiment, the bonding layer 59 can be protruded from both side surfaces of the dielectric substrates 12, and the electrode carrier film can be cut in the same plane as the side surfaces of the dielectric substrates.

### Embodiment 5

According to this embodiment, as in the case of Embodiment 4, a B-stage adhesive resin sheet is provided with punched portions each having a shape larger than the shape of the resonator electrode, and resonator electrodes made of a metal foil are disposed and inserted into the punched portions to form a pre-preg, that is, an electrode carrier film.

According to this embodiment, this electrode carrier film is interposed between a pair of large dielectric substrates. The pair of dielectric substrates have large main surfaces that can cover a large number of the resonator electrodes in the electrode carrier film. Dielectric resonators are formed by steps of applying pressure and heat to outer surfaces of the pair of dielectric substrates covering the electrode carrier film to cure the adhesive resin sheet in a B stage and thereby form a bonding layer so that the dielectric substrates and the resonator electrodes are integrally bonded by the bonding layer and cutting the laminated dielectric substrates to separate them into a large number of single dielectric resonators.

The adhesive resin sheet can be a B-stage thermosetting resin sheet or a composite film obtained by mixing a thermosetting resin in an inorganic filler. As the thermosetting resin, for example, an epoxy resin can be used. The inorganic filler can be a fine silica powder.

Instead of the adhesive resin sheet, a non-adhesive resin sheet can also be used. As such a non-adhesive resin sheet, a resin sheet having an extremely small dielectric loss tangent without adhesiveness such as polyester or tetrafluoroethylene can be used. In this case, the surface of the resin sheet is coated with an adhesive resin solution, for example, a thermosetting epoxy resin adhesive, and can be bonded to the dielectric substrates as a bonding layer. This bonding layer has an advantage that even when an electric field enters this layer, the Q value is not decreased.

In this embodiment, since a film-like bonding layer is used to provide opening portions for disposing resonator electrodes therein, an arbitrary space can be formed between the bonding layer and the resonator electrodes by making the size of the opening portions larger than the shape of the resonator electrode.

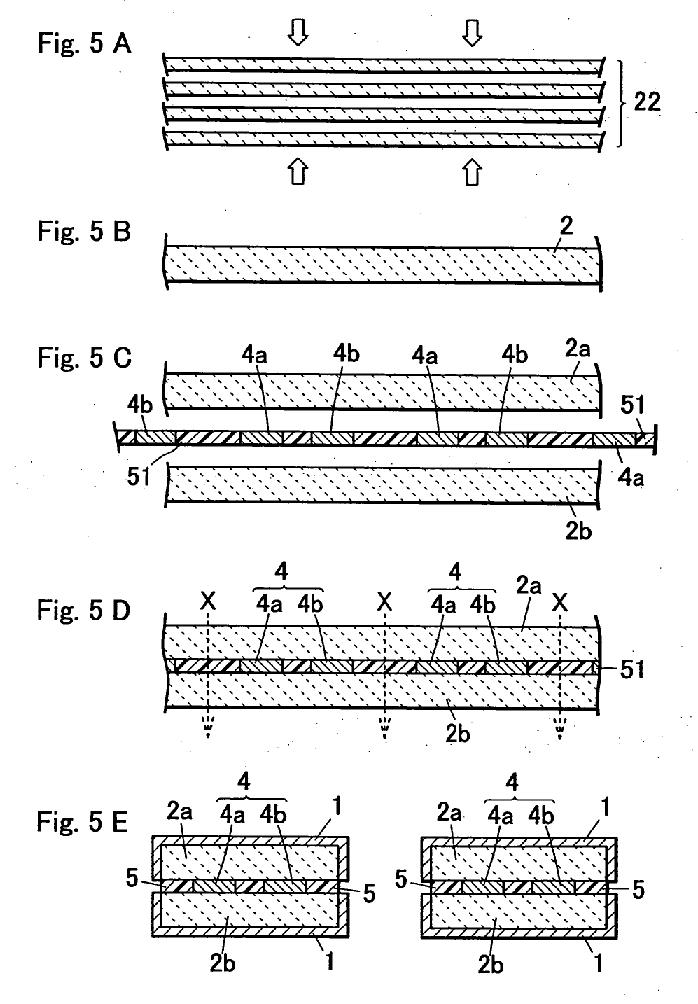

First, as shown in FIGS. 5A-5B, a plurality of dielectric ceramic green sheets 22 are laminated and sintered to form a dielectric substrate 2 in a large size.

Subsequently, resonator electrodes 4a, 4b made of a copper foil are inserted into a large thermosetting resin sheet 51 such as an epoxy resin in a B stage formed in another process to prepare an electrode carrier film. This embodiment is the same as Embodiment 4 in that the electrode carrier film 52 contains resonator electrodes 4 and a resin sheet to be a bonding layer.

As shown in FIG. 5C, this large-size electrode carrier film 52 is interposed between a pair of dielectric substrates 2a, 2b, and pressure and heat are applied to both the substrates so that the dielectric substrates 2a, 2b, the resonator electrodes 4 and the bonding layer 5 are laminated and integrally bonded. The laminated dielectric substrates 2a, 2b are cut between the resonator electrodes as shown with X in FIG. 5D, and separated into a large number of individual dielectric resonators. An external electrode 1 is electroplated on the outer surface of the separated resonator, and, as a result, a dielectric resonator is obtained as shown in FIG. 5E.

### Embodiment 6

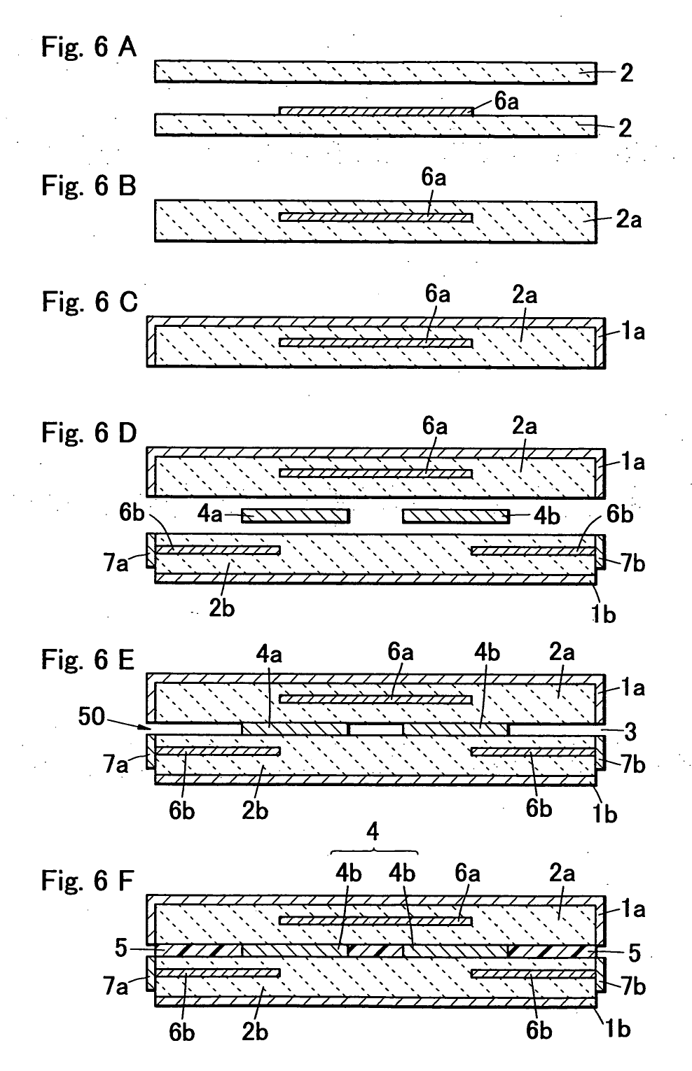

FIG. 6 shows steps of a method of producing a dielectric filter according to the present invention. The producing method is basically the same as the methods of producing the dielectric resonator in the first embodiment. Here, steps for producing an individual piece are described to simplify the explanation, but the dielectric filter of the present invention is manufactured generally by the same steps even when large-size substrates are used to produce a large number of pieces.

First, as shown in FIG. 6A, a plurality of ceramic green sheets made of a dielectric material having an extremely high Q value (for example, the fQ is about 3×10⁴ to 5×10⁴), which can be sintered at high temperature of about 1350° C., are laminated to form two dielectric substrates 2, 2. A paste containing palladium for an interstage coupling capacitor electrode 6a is printed on the upper surface of one dielectric substrate 2 as shown in FIG. 6A, the other dielectric substrate 2 is placed thereon, pressurized, and then sintered at a temperature of sintering the dielectric substrates 2, 2 as shown in FIG. 6B. As shown in FIG. 6C, after sintering, an external electrode 1a is formed on the whole surface except for the upper surface. Thus, a substrate 2a is formed in which a capacitive coupling electrode 6a is embedded.

In another similar step, an input/output coupling capacitor electrodes 6b, 6b are provided inside the dielectric substrate 2, 2 by printing a palladium paste and sintered to form a dielectric substrate 2b. A silver paste is printed on end surfaces of this dielectric substrate 2b to form input/output electrode terminals 7a, 7b and 1b is formed on the bottom surface.

As shown in FIG. 6D, the resonator electrodes 4a, 4b made of an Ag foil are disposed between the pair of dielectric substrates 2a, 2b and bonded, and then, as shown in FIG. 6E, a thermosetting resin adhesive 50 such as an epoxy resin or the like is injected and filled in a space. By curing this adhesive by heat at a predetermined temperature, as shown in FIG. 6F, the dielectric substrates and the resonator electrodes are integrally bonded by the bonding layer 5 and thus a dielectric filter is formed. In this dielectric filter, a pair of striplines 4a, 4b, which constitute resonator electrodes, are interstage-coupled in low capacitance by the interstage coupling capacitor electrode substrate 6a embedded in the dielectric substrate 2a. Furthermore, the pair of striplines are connected to the external input/output electrode terminals 7a, 7b, respectively, in low capacitance via input/output coupling capacitor electrodes 6b, 6b embedded in the other dielectric substrate 2b.

It is noted that the dielectric filter according to the present invention is not limited to this embodiment, but a bonding layer can be formed and a large number of pieces can be formed by the same producing methods as the methods of producing a dielectric resonator in the above-described Embodiments 3, 4 and 5.

### Embodiment 7

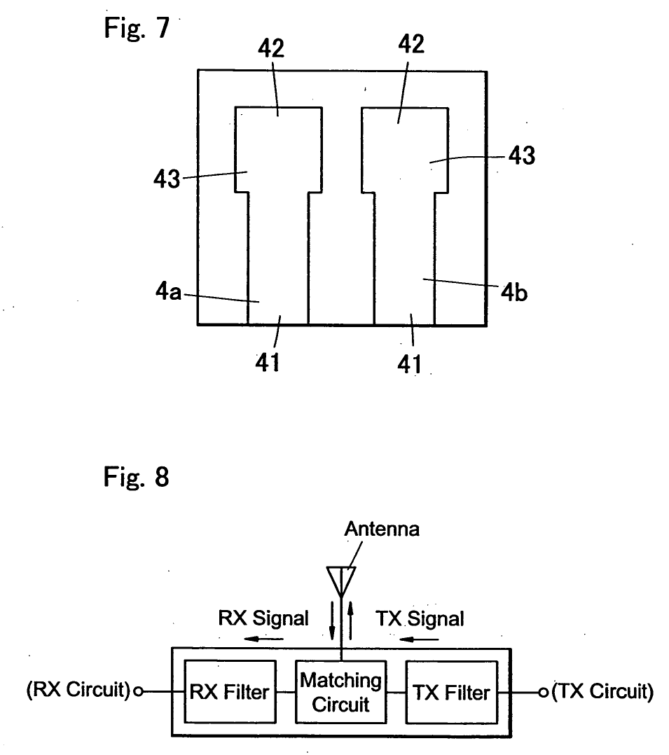

FIG. 7 is a plan view showing striplines 4a, 4b constituting resonator electrodes 4 for a dielectric resonator and a dielectric filter. The striplines 4a, 4b between a pair of dielectric substrates 2a, 2b are provided with wide portions 43 and 43 which are made wider than the strip width on the input/output sides 41 and 41, on the open end sides 42 and 42. An amount of coupling with an electromagnetic field generated between the respective resonator electrodes can be controlled by dimensions of the wide portions 43 and 43, increasing freedom in filter design.

In the producing methods shown in the above embodiments, the mean surface roughness of the dielectric substrate is preferably in the range of 0.1-2.0 μm, and bending between both ends of the dielectric substrate is preferably 10 μm or less so that a resonator with a high Q value can be obtained.

Furthermore, in some of the above embodiments, a metal foil can be used for a resonator electrode. A resonator electrode obtained by sintering a paste containing a metal powder can also be used. Examples of optimal resonator electrode materials include a copper powder, a silver powder, a mixed powder containing either of these or an alloy powder. A conductive paste of a mixture of copper or silver powder as a main component with an organic binder can also be used for printing the resonator electrode.

Furthermore, a bonding layer is selected from adhesives having permittivity of lower than ¼ times the permittivity of the dielectric substrate. Thus, decrease in the Q value of the resonator can be prevented by preventing an electric field from entering the bonding layer.

As shown in the above embodiments, since the dielectric substrates with a high fQ value obtained by sintering at high temperature (specifically, an fQ value is about 3×10⁴ to 5×10⁴) are used, and resonator electrodes having a required and sufficient thickness are integrally bonded with the dielectric substrates by the bonding layer made of a resin or a material containing a resin as a main component, a dielectric filter with a high Q value (the resonator Q is 300 to 350 when a distance between shield electrodes is 2 mm) and a dielectric filter having excellent filter characteristics such as low loss and the like can be obtained.

### Embodiment 8

The dielectric filter of the present invention can be applied to a transmitting filter and/or receiving filter in communication equipment for spectrally separating receiving waves from its own transmitting power wave, effectively. This filter may be a filter for a common transmit-receive antenna, for example, used in cellular telephone.

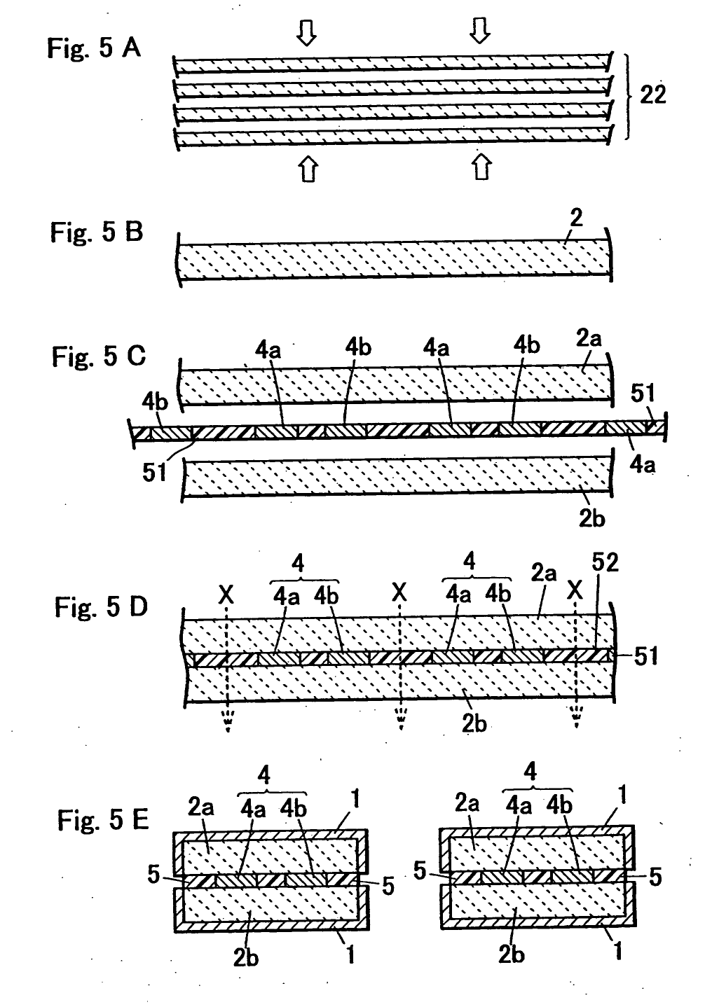

In FIG. 8, a receiving side filter and a sending side filter, which are the dielectric filters of the present invention, are disposed between an antenna and a receiver and between the antenna and a transmitter, respectively, as filters for an antenna for both sending and receiving signals. Since this can replace a conventional coaxial resonator having a large space factor, an extremely miniaturized antenna multicoupler can be obtained.

Furthermore, by using a dielectric filter or the antenna multicoupler in which the dielectric substrates and the resonator electrodes are integrally bonded by the bonding layer for communication equipment, such as a cellular phone or the like, extremely miniaturized communication equipment having excellent characteristics can be realized.

Thus, according to the embodiments of the present invention, since resonator electrodes are brought into direct contact and fixed with, for example, dielectric substrates which are sintered at high temperature in advance and have high permittivity and low dielectric loss, dielectric substrates with a high dielectric fQ value of about 3.5×10⁴can be used, the Q value can be improved up to 320 to 350, and a dielectric filter using this dielectric resonator of the present invention can significantly reduce insertion loss. Thus, the present invention can provide an excellent dielectric filter since the threshold fQ value of a dielectric that can be conventionally used is 3×10³ to 4×10³ and the Q value at 2.1 GHz of a conventional resonator is about 250.

1-11. (canceled)

12. A method of producing a dielectric resonator comprising steps of: facing the main surfaces of a pair of dielectric substrates sintered from a dielectric opposed to each other;
interposing resonator electrodes made of a metal foil therebetween and integrally bonding these; and
filling a space around the resonator electrodes between the pair of dielectric substrates with an adhesive and curing the adhesive by heating to form a bonding layer.

13. A method of producing a dielectric resonator comprising steps of: printing a pattern of an adhesive to be used as a bonding layer on a main surface of one dielectric substrate sintered from a dielectric except for regions in which resonator electrodes are to be formed;
curing the adhesive in a B stage and printing a conductive paste to be used as resonator electrodes in the regions in which the resonator electrodes are to be formed; and
placing a main surface of the other dielectric substrate sintered from a dielectric on the surface of the dielectric substrate on which the adhesive is provided, applying pressure while heating to the pair of dielectric substrates to completely cure the adhesive from a B stage and the conductive paste so that the pair of dielectric substrates, the bonding layer and the resonator electrode are integrally bonded.

14. A method of producing a dielectric resonator comprising steps of: forming an electrode carrier film composed of a resin sheet provided with punched portions each having a shape larger than the shape of a resonator electrode and resonator electrodes which are made of a metal foil and inserted into the punched portions;
interposing the electrode carrier film between a pair of dielectric substrates obtained by sintering a dielectric while their one main surfaces are opposed to each other;
applying pressure and heat to the pair of dielectric substrates to completely cure the resin sheet and thereby form a bonding layer so that the pair of dielectric substrates, the resonator electrodes and the bonding layer are integrally laminated; and
cutting the laminate to separate into dielectric resonators.

15. The method of producing a dielectric resonator according to claim 14, wherein the resonator electrodes carried on the electrode carrier film are interposed between a large number of pairs of dielectric substrates in the step of interposing the electrode carrier film; and
the resin sheet is cut between the adjacent dielectric substrates in the laminate in the separating step.

16. The method of producing a dielectric resonator according to claim 14, wherein the electrode carrier film is interposed between the pair of dielectric substrates in the step of interposing the electrode carrier film; and
the laminate of the dielectric substrates is cut between adjacent resonator electrodes in the separating step.

17. The method of producing a dielectric resonator according to claim 14, which includes a step of forming an external electrode on an outer surface of the dielectric resonator.

18. The method of producing a dielectric resonator according to claim 17, wherein the external electrode is formed by metal plating in the step of forming the external electrode.

19. The method of producing a dielectric resonator according to claim 12, the method further comprises a step of laminating a plurality of dielectric ceramic green sheets into a laminate and firing the laminate to form a dielectric substrate.

20. The method of producing a dielectric resonator according to claim 14, which the method further comprises a step of forming the external electrode on the other main surface of the pair of dielectric substrates in advance.

21-24. (canceled)

25. The method of producing a dielectric resonator according to claim 14, the method further comprises a step of laminating a plurality of dielectric ceramic green sheets into a laminate and firing the laminate to form a dielectric substrate.

26. The method of producing a dielectric resonator according to claim 13, the method further comprises a step of laminating a plurality of dielectric ceramic green sheets into a laminate and firing the laminate to form a dielectric substrate.
